(19) United States
(12) Patent Application Publication
(10) Pub. No.: US 2002/0180786 A1
(43) Pub. Date: Dec. 5, 2002

(54) Graphical user interface with embedded artificial intelligence

(76) Inventor: Robert Tanner, Boulder Creek, CA (US)

Correspondence Address: Stephen T. Neal, Blakely, Sokoloff, Taylor & Zafman LLP, Seventh Floor, 12400 Wilshire Boulevard, Los Angeles, CA, 90025-1030, US

(21) Appl. No.: 09/874,746

(22) Filed: Jun. 4, 2001

(51) Int. Cl. G09G 5/00

(52) U.S. Cl. 345/745

(57) ABSTRACT

An intelligent filter increases the user-friendliness of a computer graphical user interface (GUI) by determining user preferences based on user interaction with the GUI and changing the GUI accordingly. The filter monitors a graphical user interface to determine what frames and frame content are frequently used and remove frames and frame content of the interface that are not commonly used by an individual user. The interface is rearranged to cover any gaps. Additionally, the user is tracked to websites that the user frequents. Links to those websites are given emphasis on the rearranged user interface. The user is notified if changes are made to a favored website. The user is rewarded with discounts and other prizes for frequently going to a particular website.

### FIELD OF THE INVENTION

The present invention relates generally to computer user interfaces. More particularly, the present invention employs artificial intelligence techniques to tailor a graphical user interface.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2000, Sony Electronics, Inc., All Rights Reserved.

### BACKGROUND

Application interfaces, or “front-ends” are configurable on-demand via the use of Preference or Option pull-down menus, thus requiring user interaction. The configuration choices are limited to how cluttered the user desires the screen to be when the application is used, mainly focusing on toolbar visibility and placement. Sometimes, the choices will include aesthetic appearance, such as font and font size. In addition, some options are application specific. These options would include such web-browser options like security, the use of system resources, and receiving cookies.

This method of customization fails to serve those users who probably need the feature the most, those users with little or no computer experience. Requiring the skill necessary to perform the customization defeats the purpose of such customization, i.e. to increase the ease of use. A graphical user interface that automatically edits and reconfigures the graphical user interfaces in order to increase the ease of use of such user interfaces would be greatly beneficial.

### SUMMARY OF THE INVENTION

An intelligent filter increases the user-friendliness of a computer graphical user interface (GUI) by determining user preferences based on user interaction with the GUI and changing the GUI accordingly. The filter monitors a graphical user interface to determine what frames are frequently used and remove frames of the interface that are not commonly used by an individual user. The interface is rearranged to cover any gaps. Additionally, the user is tracked to websites that the user frequents. Links to those websites are given emphasis on the rearranged user interface. The user is notified if changes are made to a favored website. The user is rewarded with discounts and other prizes for frequently going to a particular website.

### BRIEF DESCRIPTION OF THE DRAWINGS

The present invention is illustrated by way of example and not limitation in the figures of the accompanying drawings, in which

FIG. 1 illustrates an example graphical user interface before and after editing and reorganization by the filter.

FIG. 2 illustrates a flow diagram for a method that may be used to edit and reorganize a graphical user interface to improve ease of use.

FIG. 3 illustrates a computer network topology and typical network.

FIG. 4 illustrates an architecture for a computer system.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

In one embodiment of the present invention, an intelligent filter that tailors a graphical user interface (GUI) to suit user preferences is disclosed. The preferences include the arrangement of a GUI screen, the appearance or lack of appearance of certain fields, the conspicuous visibility of frequently used functions, the ability to remember and re-establish external communications connections, and the ability to auto-configure the screen appearance based on all the above. The preferences are tracked using an application-specific embedded artificial intelligence. The screen is tailored to the context in which the user operates most frequently, thus further refining the presentation of information enhancing the user experience. The user friendliness of the GUI is increased without requiring the user to have a great deal of experience with computers.

The user-selected home page that is displayed when a web browser is opened is an example of a frequently visited web page. Many of the visible “frames” might never be selected by the user, therefore could be filtered out over time. In addition to the frames, several banner and advertising areas, configuration areas such as “one-click personalization”, and other navigational launch areas could be filtered out as well.

In one embodiment, the user configures the intelligent GUI filter preferences to hide frames not used within the last 30 days. A frame is considered accessed if the cursor is activated upon it or pauses upon it for an extended period. In one embodiment, the number of days is an arbitrary entry chosen by the user, while in an alternate embodiment the number of days is a default number. In an alternate embodiment, the user individually programs each frame when to hide. Each frame would be identified and assigned a unique identifier by the intelligent GUI filter. In a further embodiment, individual links within each frame could be “hideable” after a specified period of non-use.

As a result of the above activity, a web page would begin to show “holes” after a period of time, where the hidden frames used to be visible. The intelligent GUI filter would detect these areas of blank screen and rearrange the screen layout so the visible frames would be adjacent to one another.

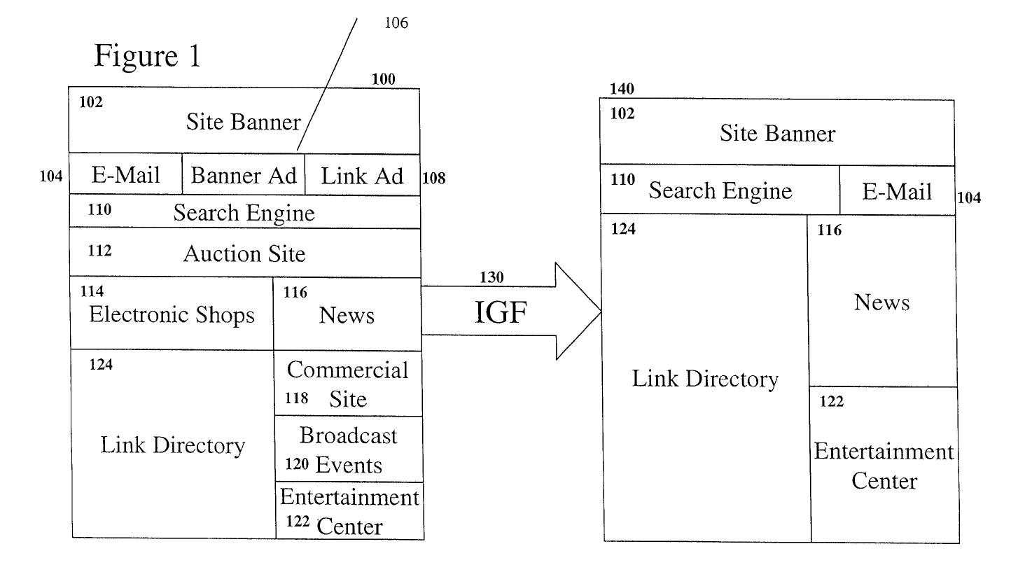

A system overview of the operation of one embodiment of the intelligent GUI filter is illustrated in FIG. 1. FIG. 1 shows a home web page 100. The home page includes a site banner 102, a hyperlink to e-mail 104, an Internet banner ad 106, a hyperlink advertisement 108, a search engine 110, auction hyperlinks 112, electronic shopping hyperlinks 114, news summary 116, commercial site hyperlinks 118, broadcast events 120, entertainment center hyperlinks 122, and a hyperlink directory 124. Most of the information cluttered onto this web page has never been useful or will ever be useful to a user. All this information detracts from that information the user wishes to seek and makes the page more difficult to use.

For example, a user may only use this web page to check the mail, get news, and search the web, with no interest in the extraneous information. The intelligent GUI filter (IGF) 130 therefore alters this web page 100 to remove the cluttering information, creating a more manageable web page 140. All that remains is the site banner 102, the hyperlink to e-mail 104, the search engine 110, the news summary 116, the entertainment center hyperlinks 122, and the hyperlink directory 124. This condensation of the web page allows the user to more effectively use the web page. The remaining information has been reorganized to hide the gaps left by the missing frames. For example, the hyperlinks to e-mail 104 has been moved to the right and the search engine 110 has been moved up and to the left to cover the disappearance of the Internet banner ad 106 and the hyperlink advertisement 108.

In a further embodiment, the most frequently used frames have precedence over the less used ones that still remain, and therefore have optimal placement priority. For example, the search engine 110 is kept close the general menu 124, where the search engine will receive the most use. In one embodiment the optimal placement would be in the top left hand portion of the web page. The same rearrangement would also be applied within frames when links are hidden due to non-use. The user could choose all the preferences for screen layout at any time. The original page layout could also be restored at any time to return full functionality to the user.

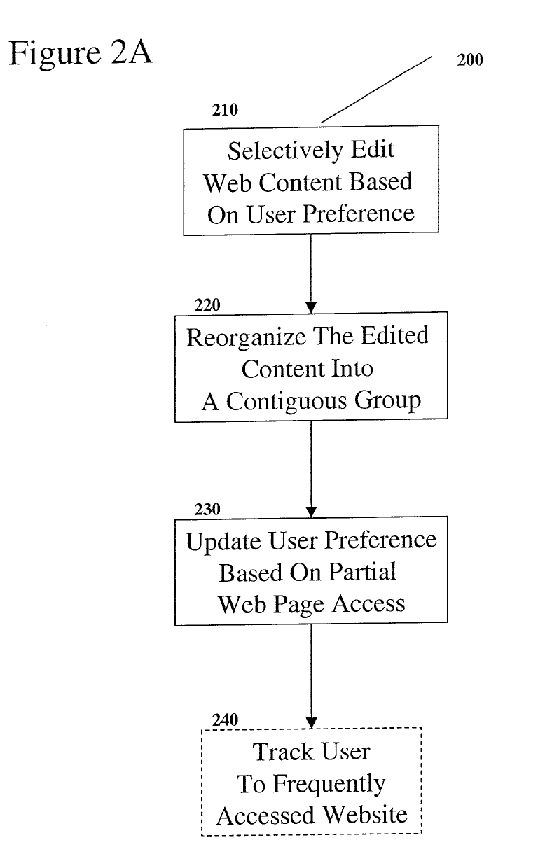

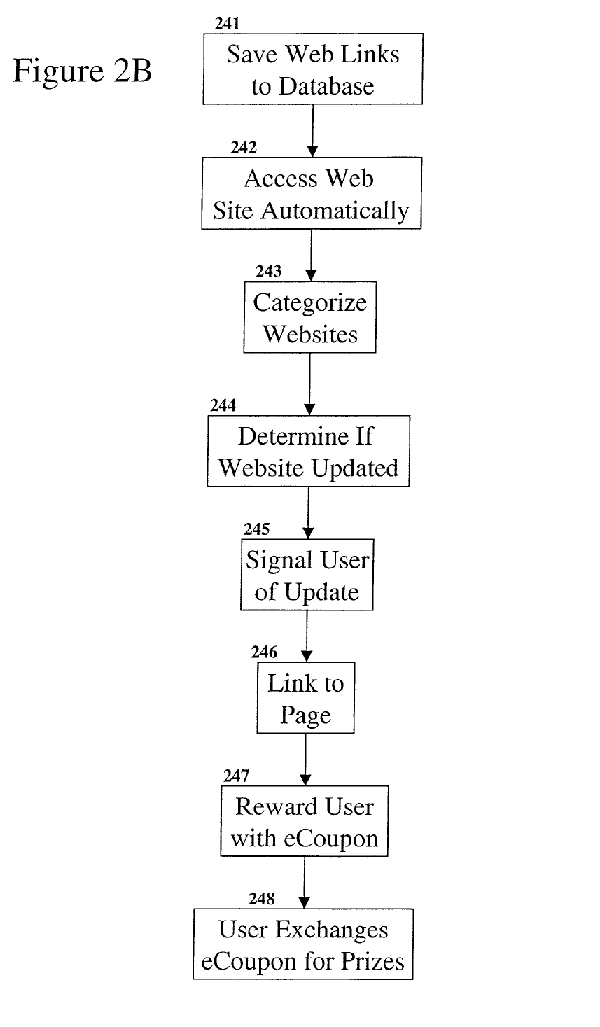

Next the particular methods of the invention are described in terms of computer software with reference to a series of flow diagrams in FIGS. 2A and 2B. The methods constitute computer programs made up of computer-executable instructions illustrated as blocks (acts) 210 to 240 in FIG. 2A and from xxx until yyy in FIG. 2B. Describing the methods by reference to a flow diagram enables one skilled in the art to develop such programs including such instructions to carry out the methods on suitably configured computers (the processor of the computer executing the instructions from computer-readable media). If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer processes may be incorporated into the methods illustrated in FIGS. 2A and 2B (flow diagrams) without departing from the scope of the invention and that no particular order is implied by the arrangement of blocks shown and described herein.

Referring first to FIG. 2A, the acts to be performed by a computer executing the intelligent GUI filter method 200 shown. The GUI filter selectively edits web content based on user preference (Block 210). The edited content is reorganized into a contiguous group (Block 220). The user preference is updated based on partial web page access (Block 230). The filter tracks the user to frequently accessed websites in order to better organize the GUI to better meet the user's needs (Block 240).

The processing represented by Block 240 is now described with reference to FIG. 2B. In an embodiment where the GUI is a browser, the most frequent use is to access web sites. These destinations are considered by the intelligent GUI filter as external communication connections, and would be saved in a database, whose limits and boundaries are set by the user at any time (Block 241). Part of the database record entry for each Uniform Resource Locator (URL) would be a context field, designating the URL destination as sports, travel, business, or other categories (Block 242). As part of the intelligent GUI filter's built-in functionality, those URL's selected by the user would be accessed automatically when the browser was invoked (Block 243). However, The URL's would be accessed only during periods of inactivity on the user's part, so as not to consume bandwidth and thereby slowing the computing platform. The purpose of accessing these selected URL's would be to determine if the web sites had been updated (Block 244).

A user-configurable indicator (one per URL) may be chosen to appear on the browser page to indicate an update (Block 245). In one embodiment, a web site dealing with the sport of golf might cause a golf ball to appear and spin in the lower corner of the page. The spin rate might be indicative for the date the page was updated—faster for an older date and slower for a more recent date. The indicator could be configured as a link to open up the page (Block 246). In one embodiment, if this link were used, an electronic coupon, or eCoupon, would be sent to the user as a reward for revisiting the web site (Block 247). This eCoupon would be exchangeable for prizes or goods for sale on that site or sites in partnership with that site (Block 248).

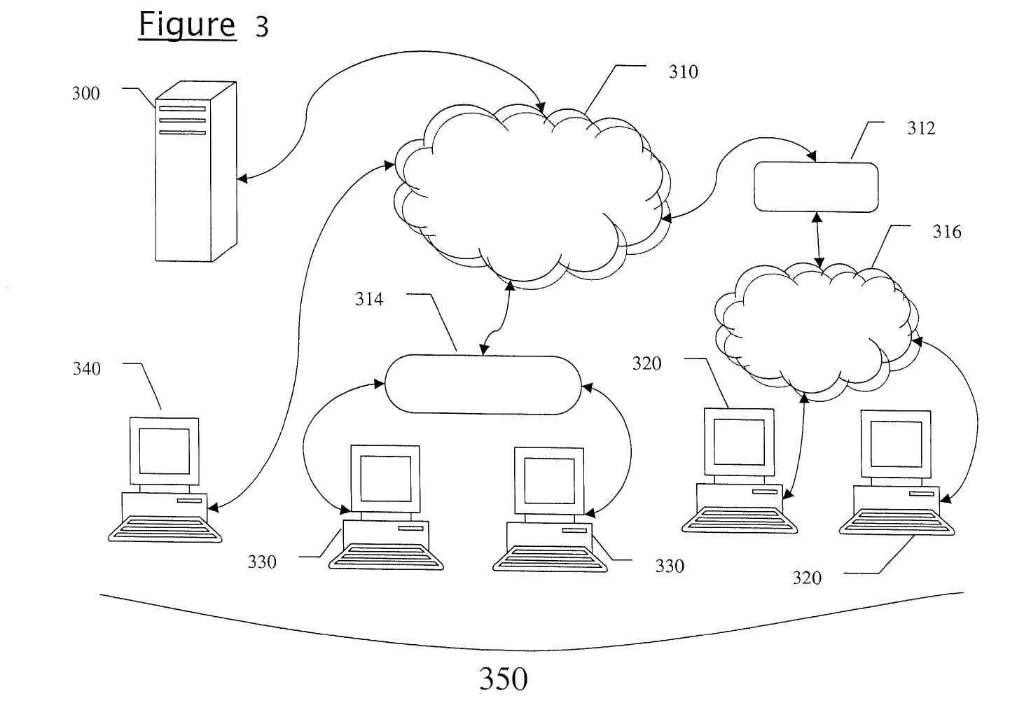

Referring now to FIG. 3, a diagram illustrates the network environment in which the method operates. In this network architecture, a server computer system 300 is coupled to a wide-area network 310. Wide-area network 310 includes the Internet, or other proprietary networks including America On-Line™, CompuServe™, Microsoft Network™, and Prodigy™, each of which are well known to those of ordinary skill in the art. Wide-area network 310 may include network backbones, long-haul telephone lines, Internet service providers, various levels of network routers, and other means for routing data between computers. Using network protocols, server 300 may communicate through wide-area network 310 to a plurality of client computer systems 320, 330, 340 connected through wide-area network 310 in various ways. For example, client 340 is connected directly to wide-area network 310 through direct or dial up telephone or other network transmission line. Alternatively, clients 330 may be connected through wide-area network 310 using a modem pool 314. A modem pool 314 allows a plurality of client systems to connect with a smaller set of modems in modem pool 314 for connection through wide-area network 310. In another alternative network topology, wide-area network 310 is connected to a gateway computer 312. Gateway computer 312 is used to route data to clients 320 through a local area network (LAN) 316. In this manner, clients 320 can communicate with each other through local area network 316 or with server 300 through gateway 312 and wide-area network 310.

Using one of a variety of network connection means, server computer 300 can communicate with client computers 350. In a particular implementation of this network configuration, a server computer 300 may operate as a web server if the World-Wide Web (WWW) portion of the Internet is used for wide area network 310. Using the HTTP protocol and the HTML or XML coding language across wide-area network 310, web server 300 may communicate across the World-Wide Web with clients 350. In this configuration, clients 350 use a client application program known as a web browser such as the Netscape™ Navigator™ formerly published by Netscape Corporation of Mountain View, Calif., the Internet Explorer™ published by Microsoft Corporation of Redmond, Wash., the user interface of America On-Line™, or the web browser or HTML/XML translator or any other well-known supplier. Using such browsers and the World-Wide Web, clients 350 may access image, graphical, and textual data provided by web server 300 or run Web application software. Means exist by which clients 350 may supply information to web server 300 through the World-Wide Web 310 and the web server 300 may return processed data to clients 350.

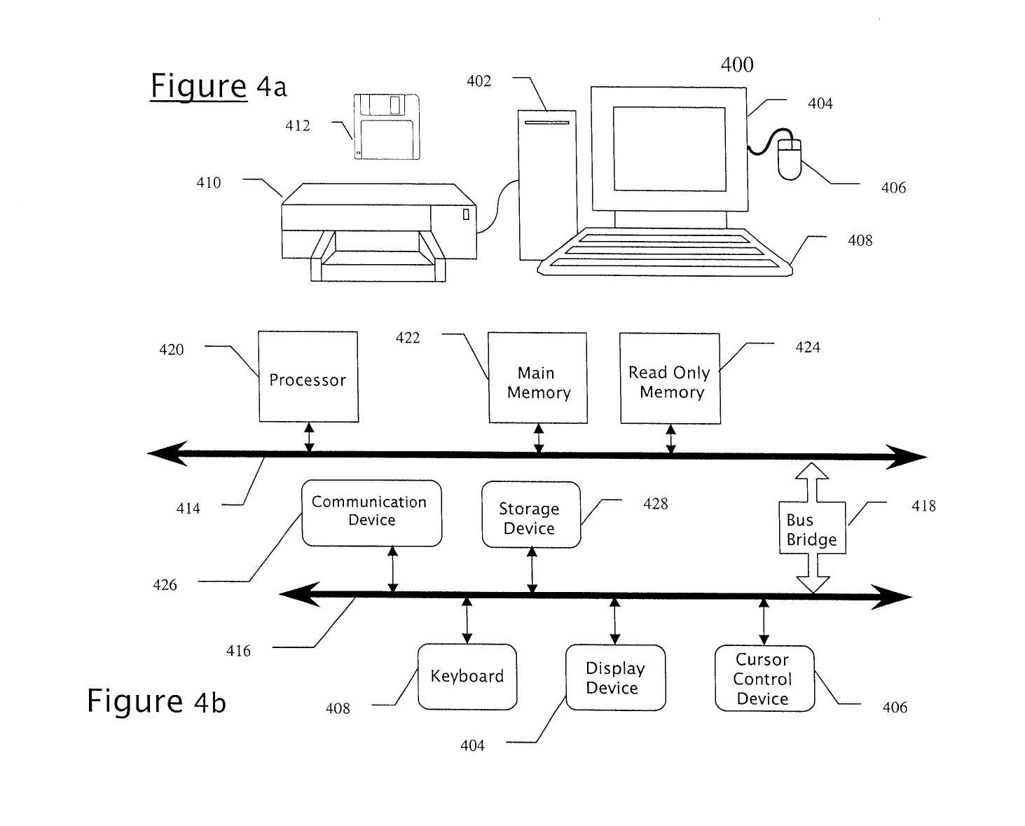

Having briefly described one embodiment of the network environment in which the method operates, FIG. 4 illustrates an example of a computer system 300 illustrating an exemplary client 350 or server 300 computer system in which the features of the method may be implemented. Computer system 400 is comprised of a bus or other communications means 401 for communicating information, and a processing means such as processor 402 coupled with bus 401 for processing information. Computer system 400 further comprises a random access memory (RAM) or other dynamic storage device 404 (commonly referred to as main memory), coupled to bus 401 for storing information and instructions to be executed by processor 402. Main memory 404 also may be used for storing temporary variables or other intermediate information during execution of instructions by processor 402. Computer system 400 also comprises a read only memory (ROM) and/or other static storage device 406 coupled to bus 401 for storing static information and instructions for processor 402.

An optional data storage device 407 such as a magnetic disk or optical disk and its corresponding drive may also be coupled to computer system 400 for storing information and instructions. Computer system 400 can also be coupled via bus 401 to a display device 421, such as a cathode ray tube (CRT) or a liquid crystal display (LCD), for displaying information to a computer user. For example, image, textual, or graphical depictions of product data and other types of image, graphical, or textual information may be presented to the user on display device 421. Typically, an alphanumeric input device 422, including alphanumeric and other keys, is coupled to bus 401 for communicating information and/or command selections to processor 402. Another type of user input device is cursor control device 423, such as a mouse, trackball, or other type of cursor direction keys for communicating direction information and command selection to processor 402 and for controlling cursor movement on display 421.

Alternatively, the client 350 can be implemented as a network computer or thin client device, such as the WebTV Networks™ Internet terminal or the Oracle™ NC. Client 350 may also be a laptop or palm-top computing device, such as the Palm Pilot™. Client 350 could also be implemented in a robust cellular telephone, where such devices are currently being used with Internet micro-browsers. Such a network computer or thin client device does not necessarily include all of the devices and features of the above-described exemplary computer system; however, the functionality of the method or a subset thereof may nevertheless be implemented with such devices.

A communication device 425 is also coupled to bus 401 for accessing remote computers or servers, such as web server 300, or other servers via the Internet, for example. The communication device 425 may include a modem, a network interface card, or other well-known interface devices, such as those used for interfacing with Ethernet, Token-ring, or other types of networks. In any event, in this manner, the computer system 400 may be coupled to a number of servers 300 via a network infrastructure such as the infrastructure illustrated in FIG. 3 and described above.

Thus, a filter to manipulate a graphical user interface in order to improve ease of use is disclosed. Although the filter is described herein with reference to a specific preferred embodiment, many modifications and variations therein will readily occur to those with ordinary skill in the art. While embodiments of the invention have been described with reference to the World-Wide Web, the method and apparatus described herein is equally applicable to other network infrastructures or other data communications systems. Accordingly, all such variations and modifications are included within the intended scope of the method as defined by the following claims.

What is claimed is:

1. A computerized method comprising:
determining a preference of a user by monitoring the user's interaction with a graphic user interface; and
selectively editing content on the graphic user interface based on the preference.

2. The computerized method of claim 1, further comprising reorganizing the edited content into a contiguous group.

3. The computerized method of claim 1, wherein the graphical user interface is a website.

4. The computerized method of claim 3, further comprising updating the preference based on access to at least a portion of a web page from the website.

5. The computerized method of claim 4, further comprising rewarding the user for actively accessing the web page.

6. The computerized method of claim 1, further comprising tracking a user to a frequently accessed website.

7. The computerized method of claim 6, further comprising categorizing the frequently accessed website.

8. The computerized method of claim 6, further comprising notifying the user when the frequently accessed website is updated.

9. A filter comprising:
a module to determine a preference of a user and to selectively edit content on a graphical user interface based on that preference.

10. The filter of claim 9, wherein the filter reorganizes the edited content into a contiguous group.

11. The filter of claim 9, wherein the graphical user interface is a website.

12. The filter of claim 11, wherein the filter updates the preference based on access to at least a portion of the website.

13. The filter of claim 11, wherein the filter rewards a user for actively accessing the website.

14. The filter of claim 9, wherein the filter tracks a user to a frequently accessed website.

15. The filter of claim 14, wherein the filter categorizes the frequently accessed website.

16. The filter of claim 14, wherein the filter notifies the user when the frequently accessed website is updated.

17. A machine-readable storage medium tangibly embodying a sequence of instructions executable by a machine to perform a method comprising:
determining a preference of a user by monitoring the user's interaction with a graphic user interface; and
selectively editing content on the graphic user interface based on the preference.

18. The machine-readable storage medium of claim 17, further comprising reorganizing the edited content into a contiguous group.

19. The machine-readable storage medium of claim 17, wherein the graphical user interface is a website.

20. The machine-readable storage medium of claim 19, further comprising updating the preference based on access to at least a portion of the web page.

21. The machine-readable storage medium of claim 19, further comprising rewarding a user for actively accessing the web page.

22. The machine-readable storage medium of claim 17, further comprising tracking a user to a frequently accessed website.

23. The machine-readable storage medium of claim 22, further comprising categorizing the frequently accessed website.

24. The machine-readable storage medium of claim 22, further comprising notifying the user when the frequently accessed website is updated.

25. A computer system comprising:
a processing unit;
a memory coupled to the processing unit through a system bus; and
a filter process executed from the memory by the processing unit, wherein the filter process causes the processing unit to selectively edit content on a graphical user interface based on user preference.

26. The system of claim 25, wherein the filter program reorganizes the edited content into a contiguous group.

27. The system of claim 25, wherein the graphical user interface is a website.

28. The system of claim 27, wherein the filter program updates the preference based on access to at least a portion of the website.

29. The system of claim 27, wherein the filter program rewards a user for actively accessing the website.

30. The system of claim 25, wherein the filter program tracks a user to a frequently accessed website.

31. The system of claim 30, wherein the filter categorizing the frequently accessed website.

32. The system of claim 30, wherein the filter notifies the user when the frequently accessed website is updated.
